(19) United States
(12) Patent Application Publication
(10) Pub. No.: US 2013/0282590 A1
(43) Pub. Date: Oct. 24, 2013

(54) ELECTRONIC PAYMENTS USING VISUAL CODE

(71) Applicant: Rajeshwar Rajarethnam, Chennai (IN)

(72) Inventor: Rajeshwar Rajarethnam, Chennai (IN)

(73) Assignee: EBAY, INC., San Jose, CA (US)

(21) Appl. No.: 13/450,925

(22) Filed: Apr. 19, 2012

(51) Int. Cl. G06Q 20/40

(52) U.S. Cl. 705/71

(57) ABSTRACT

A payer can present an electronic payment to a payee using a visual code. Such a visual code may be created by generating a semi-payment that records and secures the electronic payment to be made to the payee, encrypting a semi-payment identifier with the payee's encryption key, and encoding the encrypted semi-payment identifier into a visual code. The visual code may be received by the payee or by any user authorized to accept payments on behalf of the payee, who can accept the visual code payment by capturing the visual code using a user device. The captured visual code may be decrypted using the payee's decryption key installed on the user device, so that the semi-payment identifier can be retrieved and transmitted to a payment service provider, which completes the payment by processing the semi-payment located using the semi-payment identifier.

### BACKGROUND

1. Field of the Invention

The present invention generally relates to facilitating electronic payments, and more particularly to facilitating electronic payments in offline disconnected transactions using a visual code.

2. Description of Related Art

More and more people rely on payment service providers, such as PayPal, Inc. of San Jose, Calif., to send and receive payments. Such payment service providers can make payment transactions convenient and safe for the parties involved. Payment service providers are typically used to complete an online connected transaction. For example, consumers purchasing goods or services from online merchants can complete the purchase online and in a connected manner by making a payment for the purchase through a payment service provider.

However, a large number of transactions are still carried out offline in a disconnected manner, where some form of non-cash payment must be sent from a payer to a payee to complete a transaction. For example, application forms, such as for a college application or a passport application, are still typically in paper forms that must be mailed by applicants, along with a payment for an application or processing fee in a personal check or a cashier's check. In another example, many people and businesses still mail out paper purchase order forms, with some form of non-cash payment attached, to place an order.

In these and other offline disconnected transactions, conventional non-cash payment methods have many problems. For example, it may turn out later that a personal check, which takes days just to clear, lacks sufficient fund. A cashier's check (similarly, a certified check or a demand draft) may guarantee the availability of funds, but a payer must go to banks and other similar institutions to draw such instruments, which makes it very inconvenient. While some electronic or partially electronic payment methods (e.g., providing credit card numbers, electronic check payment, digitally originated checks under the Check 21 regulation, etc.) may be somewhat more convenient, these methods may still be problematic. For example, these methods still do not guarantee availability of funds, and some of these methods still have to go through a lengthy clearing process. Further, some of these methods involve divulging sensitive information (e.g., providing credit card numbers, checking account numbers, or other account information to a payee), which makes them vulnerable to fraudulent use by a payee or an eavesdropper.

Thus, there is a need for a convenient and safe way of presenting and accepting payments in offline disconnected transactions.

### SUMMARY

In accordance with one or more embodiments of the present disclosure, a payee, who may be a user of a payment service provider, registers the payee's encryption key with the payment service provider. If the payee does not have an encryption key, one may be generated before an encryption key can be registered. A corresponding decryption key is imported and installed in a user device of the payee or a user who is authorized to accept payments on behalf of the payee. In one embodiment, the encryption key may be a public key used in public-key cryptography (e.g., RSA cryptography) and the decryption key may be a corresponding private key.

Once the encryption key is registered and the decryption key is installed, a payer may be given an option to present an electronic payment to the payee via a visual code. The payer may take advantage of the option and send the payment service provider a request to generate an electronic payment to be presented as a visual code. In response to the request, the payment service provider creates a semi-payment from the payer to the payee in the requested payment amount. The payment amount is funded from the payer's account and secured in the semi-payment. The semi-payment is identified by a semi-payment ID, which is encrypted using the registered encryption key of the payee and then encoded into a visual code. The visual code may be printed or otherwise outputted by the payer, who can send it to the payee or to any other user who is authorized to accept payments on behalf of the payee. In one embodiment, the visual code may be a two-dimensional code, such as a Quick Response (QR) code.

When the payee or the authorized user receives the visual code and decides to accept the payment from the payer, the payee/user can conveniently scan, photograph, or otherwise capture and decode the visual code with the user device of the payee/user. Because the visual code was encrypted with the payee's encryption key, only the payee/user—whose user device should have the corresponding decryption key installed—will be able to decrypt it to retrieve the semi-payment ID. The decoded and decrypted semi-payment ID may then be transmitted to the payment service provider, which locates the corresponding semi-payment using the semi-payment ID and completes the payment by transferring the secured payment amount to an account of the payee.

Thus, users can create, present, and accept electronic payments in a safe and convenient manner, even in offline disconnected transactions.

These and other features and advantages of the present invention will be more readily apparent from the detailed description of the embodiments set forth below taken in conjunction with the accompanying drawings.

### BRIEF DESCRIPTION OF THE DRAWINGS

FIG. 1 is a block diagram of a networked system suitable for presenting and processing electronic payments using a visual code according to an embodiment of the present disclosure;

FIGS. 2A to 2B are flowcharts illustrating processes for presenting and processing electronic payments using a visual code according to an embodiment of the present disclosure; and

FIG. 3 is a block diagram of a computer system suitable for implementing one or more components of FIG. 1 according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

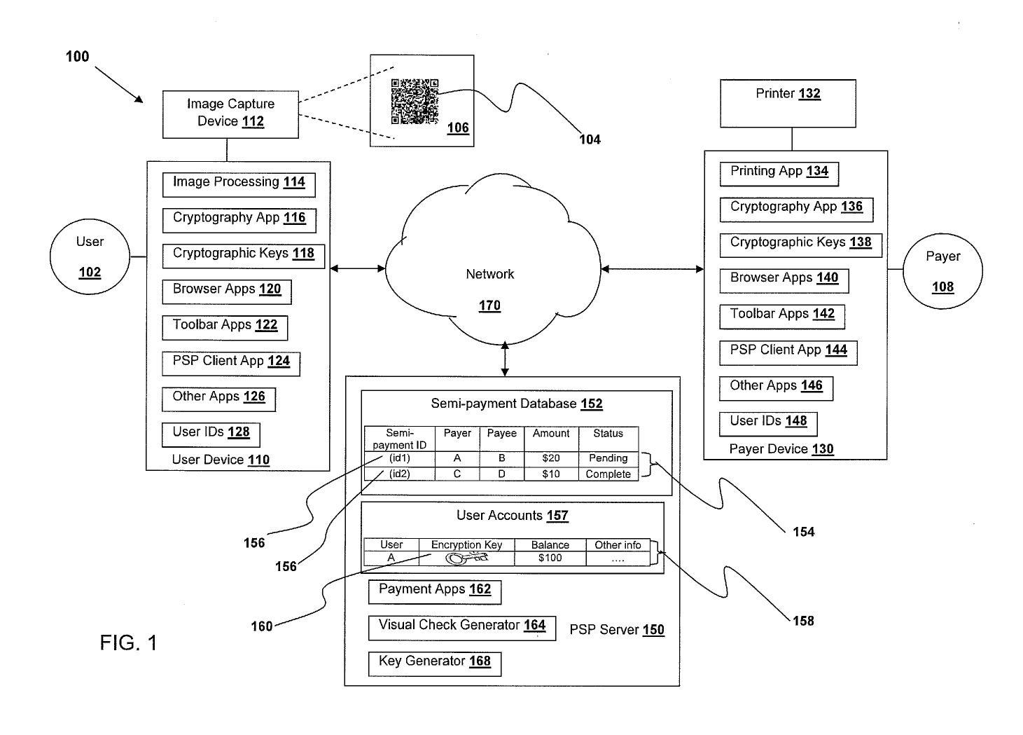

FIG. 1 is a block diagram illustrating a networked system 100 suitable for presenting and processing electronic payments using a visual code, in accordance with one or more embodiments of the invention. System 100 includes a user device 110, a payer device 130, and a payment service provider (PSP) server 150 in communication over a network 170. PSP server 150 may be maintained by a payment service provider, such as PayPal, Inc. of San Jose, Calif. Payer device 130 may be used by a payer 108 to transmit an electronic payment request to PSP server 150. User device 110 may be used by a user 102 to accept the electronic payment presented as a visual code 104. Once the electronic payment is accepted by user 102 using user device 110, PSP server 150 may complete the payment by transferring funds to an account of a payee, as further described herein.

Visual code 104 may be affixed to or printed on a tangible medium 106 (e.g., paper) User device 110 can capture or scan visual code 104, which may then be decoded or otherwise processed by user device 110 to retrieve information stored thereon. The information stored on visual code 104 may be encrypted, such that one or more cryptographic keys 118 stored on user device 110 may be used to decrypt the information, as further described herein.

In one embodiment, visual code 104 may be a two-dimensional code, such as the Quick Response (QR) code by Denso-Wave, the PDF417 code by Symbol Technologies, the DataMatrix code by RVSU Acuity Cimatrix, and the MaxiCode by UPS. Two-dimensional codes are typically able to encode large amounts of information, due in part to data being encoded in both the horizontal and vertical directions of the code. For example, some implementations of the QR code can encode over four thousand alphanumeric characters. The large capacity of two-dimensional codes may be useful, for example, in storing information encrypted with a long cryptographic key to achieve a strong encryption.

Other types of visual codes, such as various types of linear barcodes and other appropriate machine-decodable visual codes, may also be used to implement visual code 104. It is also contemplated that instead of being affixed to a tangible medium, visual code 104 may be presented on a display, for example a CRT screen, an LCD screen, a protector screen, and other appropriate displays for presenting electronically generated information.

User device 110, payer device 130, and PSP server 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

Network 170 may be implemented as a single network or a combination of multiple networks. For example, in various embodiments, network 170 may include the Internet or one or more intranets, landline networks, wireless networks, and/or other appropriate types of networks.

User device 110 may be implemented using any appropriate combination of hardware and/or software configured for wired and/or wireless communication over network 170. For example, in one embodiment, user device 110 may be implemented as a smart phone in communication with the Internet. In other embodiments, user device 110 may be implemented as a personal digital assistant (PDA), a tablet device such as an iPad™ from Apple™, a laptop computer, a desktop computer, or and/or other types of computing devices configured for wired and/or wireless communication over network 170.

As shown, user device 110 may be equipped with or capable of receiving data from an image capture device 112. Image capture device 112 may be implemented with a scanner, camera, and/or other suitable imaging sensors. User device 110 may include an image processing application 114 that receives an image scanned, photographed, and/or otherwise captured by image capture device 112, and processes the image to decode data found on the image. For example, image processing application 114 may contain software to decode an image of visual code 104 (e.g., a two-dimensional code) to retrieve information stored thereon. In some embodiments, if an image of visual code 104 is already available as a digital image file or other appropriate computer-readable format (e.g., electronically received at user device 110 via network 170), image processing application 114 may capture the image directly from such a file without relying on image capture device 112.

In addition, user device 110 may include a cryptography application 116 and one or more cryptographic keys 118 used by cryptography application 116 to encrypt and/or decrypt data. In various embodiments, cryptographic key 118 may be associated with a user of a payment service provider, such as PayPal, Inc. In one embodiment, cryptographic key 118 may be a private key of a user of a payment service provider, and cryptography application 116 may be configured to decrypt data using public-key cryptography such as the RSA algorithm. In another embodiment, cryptographic key 118 may be a symmetric key of a user of a payment service provider, and cryptography application 116 may be configured to decrypt data using symmetric-key cryptography such as the AES or the 3DES algorithm.

User device 110 may include one or more browser applications 120 which may be used, for example, to provide a convenient interface to permit user 102 to browse information available over network 170. For example, in one embodiment, browser application 120 may be implemented as a web browser configured to allow user 102 to interact with websites over the Internet, such as when interacting with PSP server 150 via web pages to create a user account, authenticate user device 110, transmit various requests including payment requests, receive and install cryptographic keys 118, transmit an acceptance of payment presented as visual code 104, receive notifications, check various statuses, and/or perform other various operations as further described herein. In this regard, user device 110 may also include one or more toolbar applications 122 which may be used cooperatively with browser application 120 (e.g., as a plug-in to a browser) to provide, for example, a client-side processing for performing various desired operations given in the preceding examples. In some embodiments, user device 110 may also include a PSP client application 124 configured to allow user 102 to interact with PSP server 150 to perform various operations, including those given in the preceding examples, without the need of a web browser and/or a toolbar.

User device 110 may further include other applications 126 as may be desired in particular embodiments to provide desired features to user device 110. For example, such other applications 126 may include security applications for implementing client-side security features, programmatic client applications for interfacing with appropriate application programming interfaces (APIs) over network 170, or other types of applications. Applications 126 may also include email and texting applications that allow user 102 to send and receive emails and texts through network 170.

User device 110 includes one or more user identifiers 128 which may be implemented, for example, as operating system registry entries, cookies associated with browser application 120, identifiers associated with hardware of user device 110, or other appropriate identifiers, such as those used for payment/user/device authentication. In one embodiment, user identifier 128 may be used by a payment service provider to associate user 102 with a particular account maintained by the payment service provider as further described herein. Note, however, that the user associated with cryptographic keys 118 may not necessarily be the same as user 102 associated with user identifier 128. For example, the user associated with one or more of the cryptographic keys 118 may be a payee to receive an electronic payment presented as visual code 104, whereas user 102 associated with user identifier 128 may be a person authorized to accept the electronic payment on the payee's behalf, so that appropriate funds will be transferred to the PSP account of the payee.

Payer device 130 may be implemented in a same or similar manner as user device 110 described above. Payer device 130 may include a cryptography application 136, one or more cryptographic keys 138, one or more browser applications 140, one or more toolbar applications 142, a PSP client application 144, other applications 146, and a user identifier 148, all of which may be implemented in a same or similar manner as various corresponding applications, data, and other hardware/software components of user device 110. In one embodiment, cryptographic key 138 may be a public key of a user of a payment service provider, and cryptography application 136 may be configured to encrypt data using public-key cryptography such as the RSA algorithm.

As shown, payer device 130 may be equipped with or capable of transmitting data to a printer 132, which may be implemented using suitable technology (e.g., inkjet printing, laser printing) known in the art for printing images on a tangible medium such as paper. Payer device 130 may further include a printing application 134 that appropriately formats image data for printing by printer 132. In one embodiment, printing application 134 may be configured to receive a digital image file (e.g., an image file of a visual code transmitted by PSP server 150) and format it for printing. In another embodiment, printing application 134 may be configured to transform data into a visual code (e.g., a QR code) formatted for printing.

PSP server 150 may be maintained, for example, by a payment service provider, which may complete an electronic payment (i.e., transfer funds to appropriate payees) requested by payer 108 when user 102 accepts the electronic payment presented as visual code 104. In this regard, payment service provider 150 may include a semi-payment database 152 that maintains one or more semi-payment records 154 identified by corresponding semi-payment identifiers (IDs) 156. Semi-payment record 154 may comprise data fields indicating a user ID of a payer, a user ID of a payee, a payment amount, status (e.g., completed or pending), and an expiration time. Semi-payment record 154 may be created when PSP server 150 receives a request to pay a payee using a visual code, for example when a payment request is received from payer 108 via payer device 130 over network 170.

PSP server 150 may also maintain a plurality of user accounts 157, each of which may include account information 158 associated with individual users. For example, account information 158 may include an account balance, an encryption key 160, and other financial and user-related information such as account numbers, passwords, device identifiers, user names, addresses, phone numbers, credit card information, bank information, PINS.

PSP server 150 includes one or more payment applications 162 which may be configured to interact with user device 110 and/or payer device 130 over network 170 to facilitate payment services, including presenting and processing an electronic payment via a visual code. As such, payment application 162 may be configured to receive a payment request from payer device 130, create a corresponding semi-payment record in semi-payment database 152, and transmit a visual code representing the semi-payment back to payer device 130.

A visual check generator 164, which may be part of payment applications 162 or separate, may be configured to transform semi-payment ID 156 into an encrypted visual code, as further described herein. For example, semi-payment ID 156 may be encrypted using encryption key 160 associated with a payee, and then the encrypted semi-payment ID may be encoded into visual code 104 to be printed by payer 108 and presented to user 102.

PSP server 150 may further include a key generator application 166 configured to generate cryptographic keys associated with users. For example, if a user does not have cryptographic keys, key generator application 166 may generate appropriate encryption and decryption keys for use with the systems and methods described herein. In one embodiment, a public/private key pair may be generated using appropriate public-key cryptography algorithms such as the RSA algorithm, and the public key may be stored as encryption key 160 in account information 158. In another embodiment, a symmetric key may be generated using appropriate symmetric-key cryptography algorithms such as the AES algorithm, and the symmetric key may be stored as encryption key 160 in account information 158.

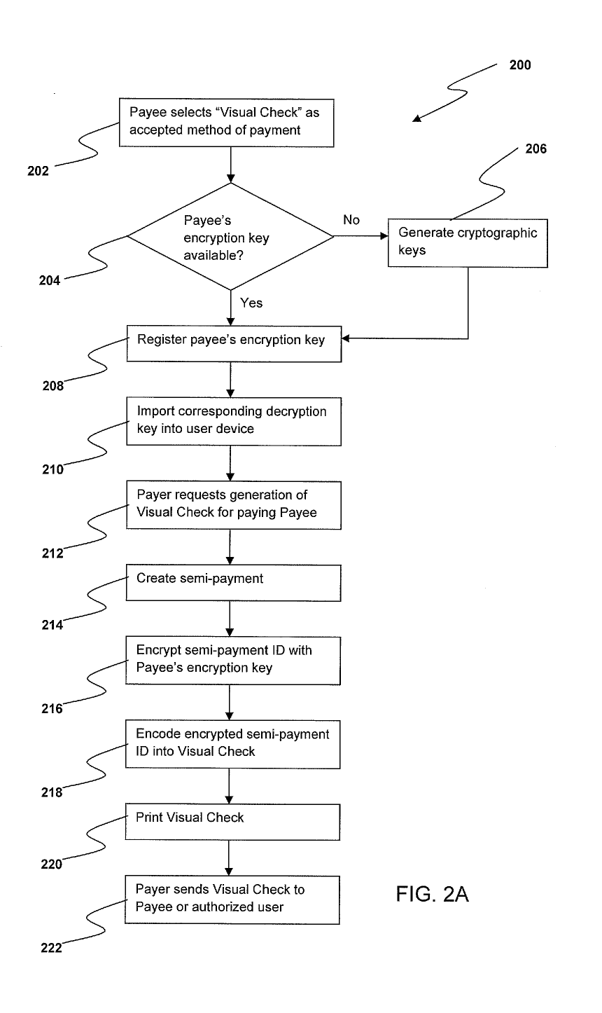

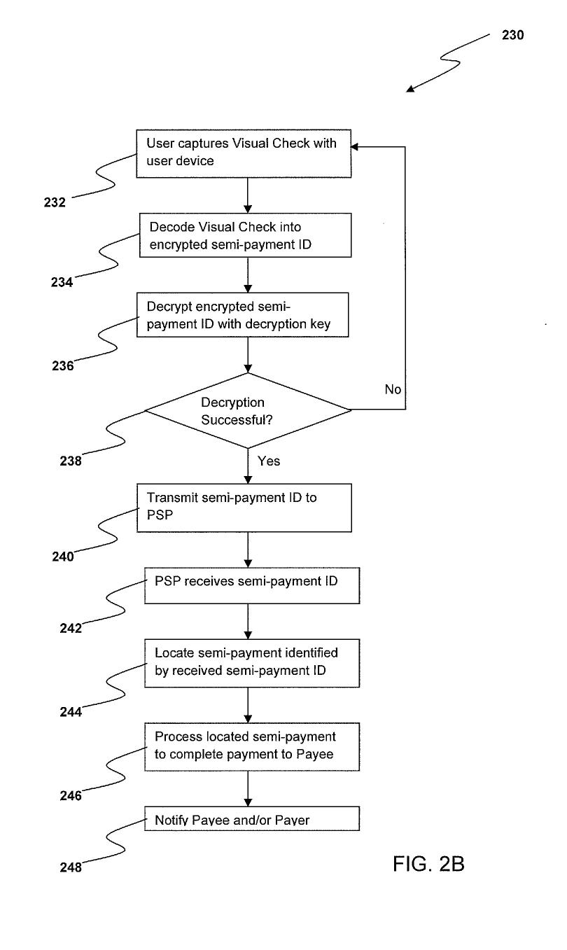

Referring now to FIGS. 2A-2B, flowcharts are shown of various processes 200, 230 for presenting and processing an electronic payment using a visual code, such as the visual code 104 of FIG. 1, in accordance with one or more embodiments of the disclosure. More specifically, FIG. 2A illustrates process 200 for generating and presenting an electronic payment as a visual code, and FIG. 2B illustrates process 230 for accepting and processing an electronic payment presented as a visual code. For purposes of simplifying the discussion of FIGS. 2A and 2B, processes 200, 230 may be described with reference to system 100 of FIG. 1 as an example of systems, devices, and components that may perform processes 200, 230. However, it will be appreciated that any other appropriate system of suitable devices and components may be used to perform all or parts of processes 200, 230.

At step 202, a payee selects a visual code payment (or a “visual check” payment) as an accepted payment method for receiving electronic payments through a payment service provider, such as PayPal, Inc. The payee may make the selection when first signing up to use the payment service provider, or anytime after signing up by accessing the payment service provider server, for example, through a web interface or through a PSP client application (e.g., PayPal Mobile App by PayPal, Inc.). In the present disclosure, a “visual check” may refer to a visual code that represents an electronic payment. A visual check, as further described herein, may be printed on or otherwise affixed to a tangible medium for delivery to a user, who can then “deposit” it on behalf of the payee (i.e., accept the visual check so that the payment service provider transfers funds to the payee) using a user device. Thus, by permitting payment through a visual check, the payee can accommodate offline disconnected transactions with payers, while still benefiting from the convenience and security of using payment service providers.

At step 204, the payee may be asked whether there is an appropriate encryption key that can be registered with the payment service provider. If so, the encryption key can be uploaded to the payment service provider server. If not, an appropriate encryption key may be generated by the payment service provider and/or the payee's user device at step 206. In some embodiments, a public/private key pair may be generated using a suitable public-key cryptography algorithm such as the RSA algorithm, where the public key may be used as an encryption key. In other embodiments, a symmetric encryption/decryption key may be generated using a suitable symmetric key algorithm such as the AES or the 3DES algorithm. The generated and/or uploaded encryption key of the payee may be registered with the payment service provider at step 208, for example, by storing the public key of the payee with the account information 158 of the payee in user accounts 156 maintained by PSP server 150.

At step 210, a corresponding decryption key may be imported into a user device. For example, the private key of the payee may be installed in user device 110 as cryptographic key 118 to be used by cryptography application 116, so that data encrypted using the corresponding public key can be decrypted on user device 110. As noted above, the user of the user device may or may not be the same as the payee. If the payee is the user of the user device, the decryption key may already be held by the payee (when the payee uploaded the corresponding encryption key or when the keys were generated by the user device) or can be transmitted from the PSP server to the payee after the keys are generated at step 206. If the payee is different from the user of the user device, the payee may need to share the decryption key with the user. In some embodiments, distribution of the decryption key may be achieved by allowing authorized users to download the key from the PSP server. For example, when selecting a visual check payment at step 202, the payee may input the user IDs of those authorized to accept the visual check. Those authorized users may download the payee's decryption key from the PSP server and import it into their user devices. The key may also be distributed to appropriate users in any other secure way, for example, by transmitting the key over a secure channel, or passing a computer-readable medium storing the key to users in person.

Once the encryption key of the payee is registered with the payment service provider and the corresponding decryption key is imported into the user devices of authorized users and/or the payee, an option may be available for a payer to pay the payee using a visual check. For example, a payer may be presented with an option to pay using a visual check when the payee is selected as the intended recipient of a payment. At step 212, a payer may select such an option and complete a payment request by entering other required information, such as the payment amount and the funding source.

In some embodiments, the payer can set up a “ripple” or “parallel” payment to multiple payees at step 212, so that appropriate funds will be transferred to multiple parties when the visual check is accepted by a user. For example, a payer can set up a parallel payment to a travel agent, an air carrier, a hotel, and a rent-a-car service, so that when the travel agent confirm a travel plan and accepts the visual check, other payees—the air carrier, the hotel, the rent-a-car service—also receives payment in their PSP account. As a result, a payer can conveniently perform multiple offline payment transactions by creating and sending only a single visual check to a payee whose acceptance of the visual check for provision of goods or services would trigger the provision of goods or services by, and the need to pay, multiple other parties. Parallel payment processing may be implemented using appropriate primitives and application programming interfaces (APIs) provided by a payment service provider, such as the Adaptive Payments API provided by PayPal, Inc.

The payment request from the payer may be received by the payment service provider, which may create a corresponding semi-payment identified by a semi-payment ID, at step 214. For example, PSP server 150 may create semi-payment record 154 including the user ID of the payer, the user ID of the payee (or the user IDs of multiple payees if parallel payment is enabled), the payment amount, the status (set as “pending” when created), and the expiration time. When a semi-payment is created, the payment service provider funds the payment amount from one or more funding sources selected by the payer (for example, at step 212), so that the payment amount is set aside and secured until the payee receives the payment in the payee's PSP account. Thus, unlike conventional disconnected electronic payment methods (e.g., providing an e-check payment, a credit card number, or a digitally originating Check21 check) that can be denied due to insufficient funds when a payee tries to cash or deposit the payment, funds to be transferred to the payee are guaranteed to be available (unless canceled or expired) when the payee accepts the visual check.

In some embodiments, the payer may be provided with an option to cancel the visual check payment. Also, the visual check may expire when the expiration time indicated in the semi-payment record is reached. The expiration time may be set by the payer (e.g., when the payer requests a payment at step 212) or may take on a default value. If the visual check is canceled or expired, the payment amount set aside in the semi-payment is released and returned to the payer's PSP account.

At step 216, the semi-payment ID created at step 214 may be encrypted using the payee's encryption key registered with the payment service provider at step 204. In embodiments where public-key encryption is used, all or part of the encryption may optionally be performed on the payer device, since a public key may be distributed to the payer without compromising the security of public-key cryptography. At step 218, the encrypted semi-payment ID is then encoded into a visual code, such as visual code 104 discussed above in connection with FIG. 1. In some embodiments, all or part of the encoding may be performed on the payer device.

The resulting visual code of the encrypted semi-payment ID may be printed or otherwise output at step 220, for example by payer 108 using payer device 130 to print visual code 104 on tangible medium 106. The visual code (or “visual check”) may be printed or output along with any other information that the payer desires to convey to the payee. For example, the visual code may be printed on an application form (e.g., a passport application form, a college application form), so that the processing fee for the application may be presented and accepted using the visual code when the form is in the hands of the intended party for processing.

In some embodiments, the PSP server may provide appropriate APIs for integrating visual check generation (for example, steps 212-218 above) into desired web pages of the payee. In the application form example above, the web page for downloading an application form may be integrated with the payment service provider via APIs, so that a payer can create a visual code on a downloaded application form directly from the download page.

At step 222, the printed or otherwise outputted visual code is sent, delivered, or otherwise appropriately transmitted to the user, who may be the payee or someone authorized to accept payment on the payee's behalf as discussed above. The user may be, for example, any employee who is authorized to accept payments on behalf of an employer. As such, there may be more than one user who may accept the visual check payment via processes described herein.

When the user decides to accept the visual check payment, the user may, at step 232, scan, photograph, or otherwise capture the visual code using the user device, such as user device 110 described above. At step 234, the captured visual code, which may have been encoded from the encrypted semi-payment ID at step 216, may be decoded back into the encrypted semi-payment ID, for example, by image processing application 114 on user device 110. If the user was the intended recipient of the visual check (i.e., the intended payee or an authorized employee of the intended payee) who has the correct decryption key installed in the user device, the encrypted semi-payment ID may successfully be decrypted at step 236.

Upon determining, at step 238, that the decryption was successful, the semi-payment ID may be transmitted to the PSP server at step 240, so that the PSP server can complete the visual check payment as described below. Alternatively, the resulting data from step 236 may be transmitted to the PSP server without step 238 determining whether or not the decryption was successful. In such an embodiment, a failed decryption may be detected at the PSP server when the transmitted semi-payment ID is invalid and/or cannot identify any semi-payment in the database.

In some embodiments, the user may be asked to provide appropriate credentials (e.g., a password, a PIN) before the semi-payment ID can be transmitted to the PSP server or before the visual check can be captured, so as to prevent unauthorized acceptance of the visual check in case the user device is in the wrong hands.

Once the successfully decrypted semi-payment ID is received by the PSP server at step 242, the semi-payment ID may be used to locate the corresponding semi-payment at step 244. For example, the semi-payment ID may be a database key, which may be used to quickly retrieve the corresponding semi-payment record from semi-payment database 152 of PSP server 150. As described above with respect to step 214, the semi-payment may hold the payment amount already funded from the payer's account, along with the user ID of the payer, the user ID of the payee (or multiple payees in case of a parallel payment), the status, and the expiration time. At step 246, the semi-payment can be processed to complete the visual check payment to the payee. That is, if the status indicates that the semi-payment is still pending and the expiration time has not been reached, the secured payment amount may be transferred to the PSP account(s) indicated payee(s) and the status may be set to complete. In different embodiments, additional information may be processed before completing or authorizing the payment, including matching a payee identifier or device identifier and/or determining payee location. Optionally, at step 248, the payer and/or payee may be notified of the acceptance and completion of the visual check payment. For example, the payer and/or payee may be notified by the PSP server via email, SMS text, and/or push notification.

Thus, unlike conventional disconnected electronic payment methods such as e-check or digitally originating Check21 item which requires a lengthy clearing process (e.g., through automated clearing house (ACH)), accepting a visual check instantly transfers secured funds to the PSP account of the payee. Further, there is no danger of multiple withdrawals, since a semi-payment may be completed only once.

It will also be appreciated that a visual check payment described above is much safer than conventional disconnected payment methods. Conventional disconnected payment methods typically require that sensitive information (e.g., a credit card number or a checking account number) be transmitted to and shared with a payee, and thus remain vulnerable to fraudulent use by an eavesdropper or by the payee. In contrast, because what is delivered via a visual check is a semi-payment ID of a semi-payment predetermined to be paid only to the intended payee, an unscrupulous party cannot defraud the payer or the payee even if the semi-payment ID is revealed due to a compromised decryption key and/or a stolen user device.

Moreover, a visual check payment is convenient for both a payer and a user/payee accepting the visual check. In various embodiments, a payer can simply request a visual check payment through a payment service provider webpage, a payee's webpage (if integrated with a payment service provider via APIs), or a PSP client application, as was done for other types of payment through a payment service provider. In various embodiments, a user/payee can simply capture a visual check using a user device, such as a smart phone with an integrated camera, to accept a visual check payment. Owing to the widespread use of smart phones integrated with a camera and capable of running an application to capture various visual codes, setting up for accepting visual check payments may be as simple as downloading an appropriate client application to their smart phones, rather than having to invest money and effort in new equipment.

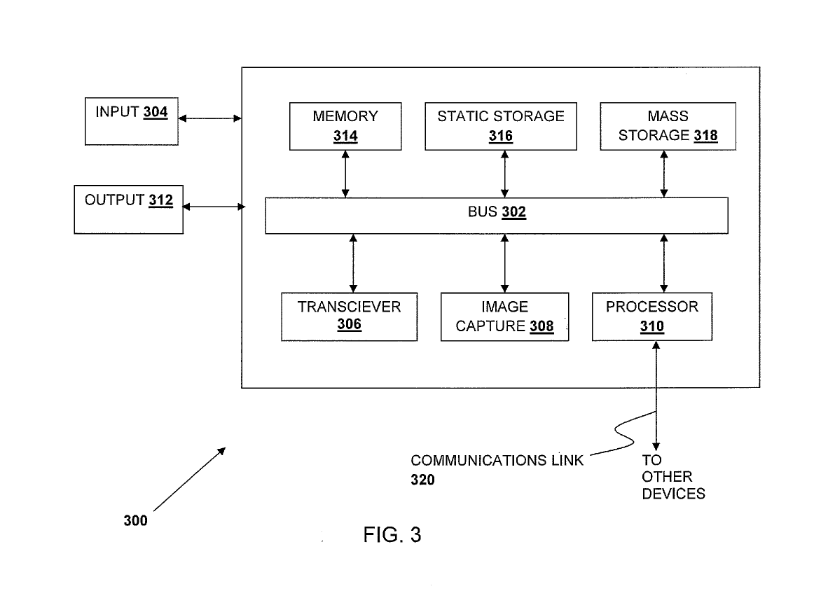

FIG. 3 is a block diagram of a computer system 300 suitable for implementing one or more devices or servers of FIG. 1, according to one or more embodiments of the present disclosure. In various implementations, the user or payer device may comprise a personal computing device (e.g., a personal computer, laptop, cell phone, PDA, tablet device, etc.) capable of communicating with the network. A payment service provider may utilize a network computing device (e.g., a network server) capable of communicating with the network. It should be appreciated that each of the devices utilized by users (including payers and payees) and payment providers may be implemented as computer system 300 in a manner as follows.

Computer system 300 includes a bus 302 or other communication mechanism for communicating information data, signals, and information between various components of computer system 300. Components include an input component 304 that processes a user action, such as selecting keys from a keypad/keyboard, selecting one or more buttons or links, etc., and sends a corresponding signal to bus 302. A transceiver 306 transmits and receives signals between computer system 300 and other devices, such as a PSP server or another user device. In one embodiment, the transmission is wireless, although other transmission mediums and methods may also be suitable. An image capture component 308, which may be implemented with a scanner, camera, and/or other suitable imaging sensors, captures an image, such as an image of visual code 104. A processor 310, which can be a micro-controller, digital signal processor (DSP), or other processing component, processes these various signals, such as for display on computer system 300 or transmission to other devices via a communication link 320. The captured image from image capture component 308 may be processed within image capture component 308 or by processor 310. An output component 312, which may include a printer implemented using suitable technology (e.g., inkjet printing, laser printing, thermal printing) and a display (e.g., a CRT screen, an LCD screen, a projector, etc.), prints or otherwise displays data or an image generated by processor 310, such as an image of visual code 104.

Components of computer system 300 also include a system memory component 314 (e.g., RAM), a static storage component 316 (e.g., ROM), and a mass storage component 318 (e.g., hard drive). Computer system 300 performs specific operations by processor 310 and other components by executing one or more sequences of instructions contained in system memory component 314. Logic may be encoded in a computer readable medium, which may refer to any medium that participates in providing instructions to processor 310 for execution. Such a medium may take many forms, including but not limited to, non-volatile media, volatile media, and transmission media. In various implementations, non-volatile media includes optical or magnetic disks, volatile media includes dynamic memory, such as system memory component 314, and transmission media includes coaxial cables, copper wire, and fiber optics, including wires that comprise bus 302. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 320 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method of facilitating electronic payments, the method comprising:
receiving, electronically by a processor of a payment service provider, a semi-payment identifier (ID) from a user device, the semi-payment ID being decrypted from a visual code that is captured at the user device, wherein the visual code is decrypted using a first key of a payee;
locating, by the processor, a semi-payment identified by the semi-payment ID; and
processing, by the processor, the semi-payment to transfer funds to the payee.

2. The method of claim 1, wherein the visual code is a two-dimensional code.

3. The method of claim 2, wherein the visual code is a quick response (QR) code.

4. The method of claim 1, wherein the visual code is generated through a process comprising:
receiving, electronically by the processor, a request to pay the payee via visual code;
generating, by the processor, the semi-payment corresponding to the request, wherein the semi-payment is identified by the semi-payment ID;
encrypting the semi-payment ID with a second key of the payee; and
encoding the encrypted semi-payment ID into the visual code.

5. The method of claim 4, wherein the encrypting the semi-payment ID and/or encoding the semi-payment ID into the visual code are performed at the payment service provider.

6. The method of claim 4, wherein the first key and second key of the payee were generated by the payment provider.

7. The method of claim 4, wherein the first key is a private key of the payee and the second key is a corresponding public key of the payee.

8. The method of claim 4, wherein the first key and second key are the same.

9. The method of claim 1, wherein the processing the semi-payment comprises transferring funds secured for the semi-payment to an account of the payee.

10. A payment service provider system, comprising:
a memory storing information about user accounts and payment transactions, wherein the information comprises cryptographic keys associated with users; and
a processor in communication with the memory, wherein the processor is configured to:
receive a semi-payment identifier (ID) from a user device, the semi-payment ID being decrypted from a visual code that is captured at the user device, wherein the visual code is decrypted using a first key of a payee;
locate, from the payment transactions information stored in the memory, a semi-payment identified by the semi-payment ID; and
process the semi-payment to transfer funds to the payee.

11. The system of claim 10, wherein the visual code is a two-dimensional code.

12. The system of claim 11, wherein the visual code is a quick response (QR) code.

13. The system of claim 10, wherein the visual code is generated through a process comprising:
receiving, electronically by the processor, a request to pay the payee via visual code;
generating, by the processor, the semi-payment corresponding to the request, wherein the semi-payment is identified by the semi-payment ID;
encrypting the semi-payment ID with a second key of the payee; and
encoding the encrypted semi-payment ID into the visual code.

14. The system of claim 13, wherein the encrypting the semi-payment ID and/or encoding the semi-payment ID into the visual code are performed by the processor of the system.

15. The system of claim 13, wherein the first key and second key of the payee were generated by the processor of the system.

16. The system of claim 13, wherein the first key is a private key of the payee and the second key is a corresponding public key of the payee.

17. The system of claim 13, wherein the first key and second key are the same.

18. The system of claim 13, wherein the processor is further configured to transfer funds secured for the semi-payment to an account of the payee.

19. A non-transitory machine-readable medium comprising a plurality of machine-readable instructions which, when executed by one or more processors, cause the one or more processors to perform a method comprising:
receiving, at a payment service provider, a semi-payment ID from a user device, the semi-payment ID being decrypted from a visual code that is captured at the user device, wherein the visual code is decrypted using a first key of the payee;
locating a semi-payment identified by the semi-payment ID; and
processing the semi-payment to transfer funds to the payee.

20. The non-transitory machine-readable medium of claim 19, wherein the visual code is generated through a process comprising:
receiving, at the payment service provider, a request to pay the payee via visual code;
generating the semi-payment corresponding to the request, wherein the semi-payment is identified by the semi-payment ID;
encrypting the semi-payment ID with a second key of the payee; and
encoding the encrypted semi-payment ID into the visual code.
